(19) United States
(12) Patent Application Publication
(10) Pub. No.: US 2013/0179538 A1
(43) Pub. Date: Jul. 11, 2013

(54) HIERARCHICAL INFRASTRUCTURE FOR NOTIFICATION OF NETWORK EVENTS

(71) Applicants: Debojyoti DUTTA, Santa Clara, CA (US); Arun Kumar GOEL, Sunnyvale, CA (US); Ganesh RAJAN, Saratoga, CA (US); Sivakumar NARAYANAN, San Jose, CA (US); Gopal K. DOMMETY, Menlo Park, CA (US)

(72) Inventors: Debojyoti DUTTA, Santa Clara, CA (US); Arun Kumar GOEL, Sunnyvale, CA (US); Ganesh RAJAN, Saratoga, CA (US); Sivakumar NARAYANAN, San Jose, CA (US); Gopal K. DOMMETY, Menlo Park, CA (US)

(21) Appl. No.: 13/347,307

(22) Filed: Jan. 10, 2012

(51) Int. Cl. G06F 15/16

(52) U.S. Cl. 709/217

(57) ABSTRACT

Techniques are described for reporting and monitoring network devices using microblog messaging. Embodiments monitor network traffic traversing a network device and performance metrics of the network device to detect occurrences of network and performance events. In response to detecting an occurrence of an event, a microblog message is generated. The microblog message contains at least a description of the occurrence. The microblog message is transmitted to a microblog service, which in turn forwards the message to subscribers. The microblog message may then be analyzed by the subscribers to determine operational attributes of the network device.

### TECHNICAL FIELD

Embodiments presented in this disclosure generally relate to network management and, more particularly, to enabling network devices to publish information in a hierarchical environment.

### BACKGROUND

As computer networks continue to expand, both at the infrastructure level and at the business level, the number of routers service providers and businesses manage has substantially increased. As a result, a number of techniques have been developed to remotely monitor the operation of network devices that make up the computer networks, such as routers and switches. For example, large networks are frequently monitored using a variety of different remote monitoring tools, including periodically polling network devices in the network for performance metric data. Through the use of such techniques, network administrators may detect problems on the network as soon as the problems occur, and in some circumstances, may even detect signs of the problems before the problems occur. Doing so enables network administrators to promptly (or even preemptively) remedy problems with the network.

However, such solutions frequently scale poorly, as the monitoring systems must continually poll the network devices at periodic intervals. Such continuous polling may result in a substantial amount of traffic and workload. Moreover, under such a model, the monitoring system sends requests to a network device at each interval, regardless of whether a problem is occurring on the network device and regardless of whether a state of the network device has changed since the previous request. While the monitoring system may be configured to poll at less frequent intervals, doing so may reduce the speed in which the monitoring system may detect network problems.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIGS. 1A-1B are block diagrams illustrating devices and systems configured according to embodiments presented in this disclosure.

FIG. 2 illustrates a topological diagram of a hierarchical network environment, according to one embodiment presented in this disclosure.

FIG. 3 is a flow diagram illustrating a method for publishing network event data, according to one embodiment presented in this disclosure.

FIG. 4 is a flow diagram illustrating a method for performing trend analysis for a plurality of network devices, according to one embodiment presented in this disclosure.

FIG. 5 is a flow diagram illustrating a method for aggregating microblog messages, according to one embodiment presented in this disclosure.

FIG. 6 is a block diagram illustrating a network environment configured with a microblog analysis component, according to one embodiment presented in this disclosure.

### DESCRIPTION

### Overview

Embodiments provide a method for reporting events on a network device. The method includes monitoring network traffic traversing the network device to detect network events. The method further includes monitoring one or more performance metrics of the network device to detect performance events. Additionally, the method includes, in response to at least one occurrence of network events and performance events, generating a microblog message containing at least a description of the occurrence. The method further includes transmitting the generated microblog message to a microblog service, whereby the microblog service forwards the microblog message on to one or more subscribers.

Additional embodiments include a system having a processor and a memory storing a program configured to perform the aforementioned method, and software embodied in a computer readable medium storing a program configured to perform the aforementioned method.

Another embodiment includes a method for monitoring a plurality of network devices. The method includes sending a request to subscribe to microblog messages sent from each of the plurality of network devices. The method further includes receiving a plurality of microblog messages from the plurality of network devices. Additionally, the method includes analyzing the plurality of microblog messages to determine one or more operational attributes of the plurality of network devices.

### Description of Example Embodiments

Embodiments provide techniques for monitoring network devices using a hierarchical publish/subscribe infrastructure. In particular embodiments, one or more network devices may be configured with a microblog component, which is capable of generating and sending microblog messages. Generally, the term “microblogging” refers to an architecture where one or more subscriber entities may subscribe to a particular type of message, and when a message of that type is published, the message is transmitted to each of the subscriber entities. For instance, a number of subscriber entities may subscribe to all microblog messages published by a particular microblogging entity. When the microblogging entity then publishes a new microblog message, a microblog service may transmit the new microblog message to each of the subscriber entities. As used herein, a microblog message generally refers to any message that may be transmitted to a microblog service. Typically, microblog messages are limited in the size of the messages that can be transmitted (e.g., 140 characters), and may further be limited as to what content may be included in the messages. More generally, however, any microblogging service capable of performing the functions described herein may be used in accordance with embodiments presented in this disclosure.

The network devices may further be configured with an event detection component. The event detection component may generally monitor events on the network device and/or network traffic traversing the network device. Examples of such events include, without limitation, performance events (e.g., CPU usage on the network device), network events (e.g., bandwidth usage) and content events (e.g., a particular type of network traffic passing through the network device). When the event detection component detects the occurrence of a relevant event, the microblog component may create a new microblog message based on the detected event. Such a microblog message may contain, for instance, an indication of the detected event, a description of the detected event, data associated with the detected event (e.g., contents of a packet which triggered the event), and so on. In one embodiment, the microblog message is defined using a markup language (e.g., Extensible Markup Language (“XML”)). Once the microblog message is created, the microblog component on the network device may transmit the created microblog message to a microblog service.

In response, the microblog service may identify one or more subscriber entities that should receive the microblog message. As discussed above, such subscriber entities may subscribe to, for example, all the messages published by the network device or for a particular subset of messages published by the network device. Once the subscriber entities for the microblog message are identified, the microblog service may transmit the microblog message to each of the subscriber entities.

For the purposes of this example, assume that one of the subscriber entities receiving the microblog message is an analysis system, configured to monitor the performance of the network device. Once received, the analysis system may analyze the microblog message to determine operational attributes of the network device publishing the message. In one embodiment, the analysis system analyzes the microblog message based on predefined information (e.g., a threshold constituting a high amount of memory). For example, if the microblog message was created in response to the event detection component detecting high memory and CPU consumption on the network device, the analysis system may determine that the network device is under a heavy workload and could soon run out of system resources. In such a case, the subscriber entity (i.e., the analysis system in this example) could be configured to perform the appropriate corrective actions for the network device, based on the analysis of the microblog message. For example, the subscriber entity may reduce the amount of traffic passing through the network device (e.g., by altering load balancing between routers to direct traffic away from the network device).

To continue with this example, the analysis system could itself also create a microblog message, based on its analysis of the received microblog message, and transmit it to the microblog service for transmittal to other subscriber entities. For instance, the analysis system could create a microblog message describing the received microblog event. For instance, the newly-created microblog message could include text such as “Network device experiencing high resource usage.” The newly-created microblog message could then be transmitted to the microblog service, and subsequently forwarded on to subscriber entities for the analysis system. For instance, a network administrator may subscribe to microblog messages from the analysis system, and receive the newly-created microblog message (e.g., using mobile telephone) describing the resource usage of the network device. Advantageously, doing so may provide an alert to the network administrator in real-time regarding potential problems occurring on the network devices. Additionally, by using a publish-subscribe microblog architecture, embodiments presented in this disclosure improve scalability over more traditional polling techniques for monitoring network devices.

In one embodiment, an aggregation device may be used to consolidate microblog messages from a group of network devices. For instance, a set of network devices may designate a single one of the network devices as the aggregation device. The aggregation device may subscribe to the microblog messages from each of the other network devices, consolidate these microblog messages, and may then create a new microblog message based on the consolidated microblog messages. For instance, the new microblog message created by the aggregation device may contain, without limitation, an indication of each of the consolidated microblog messages, a description of each of the messages, or data contained in each of the messages. The aggregation device may then transmit the new microblog message to a microblog service, whereby the microblog message is then transmitted to one or more subscriber entities (e.g., the analysis system mentioned above). The subscriber entities may then use the aggregated microblog messages to identify trends for the network device (or across multiple network devices). As an example, a subscriber entity could determine, based on the aggregated microblog messages, that a particular group of network devices are experiencing a particularly high workload at certain hours of the day, and may perform corrective actions (e.g., load balancing) in order to account for this trend. Advantageously, embodiments create a hierarchical structure which enables the subscriber entities to subscribe to fewer microblog messages, thus improving scalability of the system and creating a more intuitive environment configuration.

Additionally, presented in this disclosure may improve performance and scalability of the system as well. For instance, the network devices may transmit microblog messages to the aggregation devices over an internal network at higher speeds, and once the messages are consolidated, the aggregation device may publish a single message to a subscriber entity over a slower, external network (e.g., the Internet). Advantageously, doing so enables the network devices to maximize the usage of the faster, internal network when publishing the microblog messages. Furthermore, although the present example refers to an aggregation device being a network device which aggregates the microblog messages of other network devices, such a configuration is without limitation and is provided for illustrative purposes only. To that end, it is broadly contemplated that the aggregation device may be any device or computer system capable of performing the functions described herein.

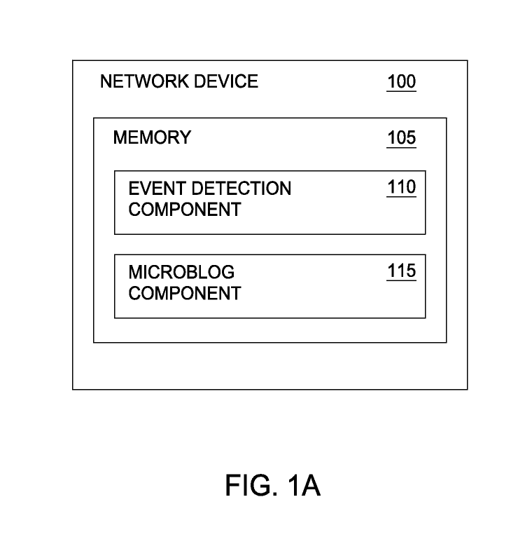

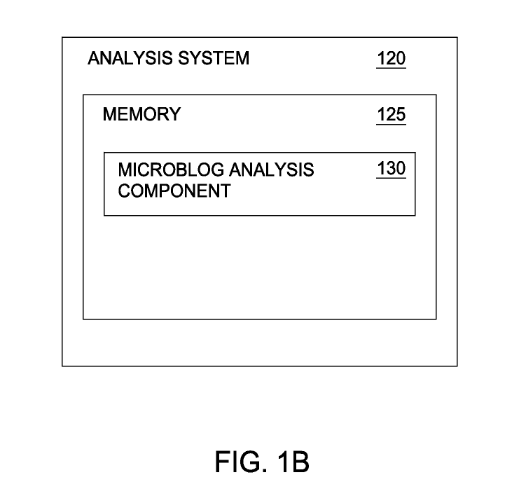

Referring now to FIGS. 1A-1B, FIGS. 1A-1B are block diagrams illustrating devices and systems configured according to embodiments described in this disclosure. FIG. 1A is a block diagram illustrating a network device, according to one embodiment presented in this disclosure. As shown, the network device 100 includes a memory 105, which in turn contains an event detection component 110 and a microblog component 115. Generally, the memory 105 is any memory sufficiently large to hold the necessary programs and data structures. Memory 105 could be one or a combination of memory devices, including Random Access Memory, nonvolatile or backup memory (e.g., programmable or Flash memories, read-only memories, etc.). In addition, memory 105 may be considered to include memory physically located elsewhere; for example, on another computer coupled to the network device 100.

As discussed above, the event detection component 110 may monitor one or more events related to the network device 100. For instance, the event detection component 110 may monitor resource usage (e.g., CPU usage, memory usage, etc.) of the network device to detect the occurrence of one or more performance events. As an example, the event detection component 110 may be configured (e.g., by a network administrator) so that when memory consumption on the network device 100 exceeds 80%, such an event could be reported in a microblog message. Thus, continuing the example, the microblog component 115 may create a microblog message based on the occurrence of the event and transmit the microblog message to a microblog service. In turn, the service publishes the to the relevant subscriber entities, notifying such subscriber entities that the performance event has occurred on the network device 100.

As a second example, the event detection component 110 may monitor network traffic passing through the network device 100 to identify when a specified network events has occurred. Examples of such events include network performance events (e.g., when bandwidth consumption exceeds a predefined threshold amount) and content events (e.g., when a particular type of traffic passes through the network device). For instance, the event detection component 110 may be configured to detect content events related to Peer-to-Peer (“P2P”) traffic. In such a configuration, the event detection component 110 may monitor network traffic passing through the network device 100, and upon determining a particular packet (or series of packets) is related to P2P activity, may trigger an occurrence of the content event. The microblog component 115 may then create a new microblog message based on the event and may transmit the microblog message to a microblog service. In one embodiment, the microblog message is defined using a markup language (e.g., XML). In response, the service may further transmit the message to one or more subscriber entities.

As discussed above, according to one embodiment, such a subscriber entity may be an analysis system which analyzes the microblog message to determine operational characteristics of the network device 100. Referring now to FIG. 1B, FIG. 1B is a block diagram illustrating an analysis system, according to one embodiment presented in this disclosure. As shown, the analysis system 120 includes a memory 125, which in turn contains a microblog analysis component 130. Similar to the memory 105 of the network device 100, the memory 125 may be any memory sufficiently large to hold the necessary programs and data structures (i.e., the microblog analysis component 130). Memory 125 could be one or a combination of memory devices, including Random Access Memory, nonvolatile or backup memory (e.g., programmable or Flash memories, read-only memories, etc.). In addition, memory 125 may be considered to include memory physically located elsewhere; for example, on another computer coupled to the analysis system 120.

The microblog analysis component 130 may generally subscribe to microblog messages from one or more network devices. In one embodiment, the microblog analysis component 130 may subscribe directly to messages published from the network devices. Alternatively, the microblog analysis component 130 may subscribe to messages published by one or more aggregation devices. These aggregation devices, in turn, subscribe to and receive microblog messages from other aggregation devices, network devices, or both. In any event, once the microblog analysis component 130 subscribes to a particular set of event messages, it then receives such messages as they are published by the network devices. The microblog analysis component 130 may then analyze messages to determine operational characteristics of the network device (or devices) sending the message(s). In one embodiment, the microblog analysis component 130 analyzes the messages using predefined information. For example, the microblog analysis component 130 may compare a CPU usage measurement from a particular message to a predefined threshold for CPU usage to determine if the CPU usage measurement indicates a high amount of CPU usage. If the determined operational characteristics indicate a problem with the network device, the microblog analysis component 130 may perform corrective actions. As discussed above, such corrective actions may include affirmative actions (e.g., altering the load balancing between a group of network devices to reduce the load of the network device having the problem) and reporting actions (e.g., generating another microblog message describing the problem for publication to a subscribing network administrator).

Additionally, the microblog analysis component 130 may collect data from microblog messages and use the collected data to determine trends for the network device. For instance, while the microblog analysis component 130 may not be concerned with a momentary spike in CPU usage on the network device, if the microblog analysis component 130 determines that CPU usage is constantly hovering near 100% usage, the microblog analysis component 130 may determine that the workload of the network device is too high. Continuing this example, if the microblog analysis component 130 identifies a trend where the workload of the network device is consistently high over a period of time, the microblog analysis component 130 may determine that a malicious attack (e.g., a denial of service attack) is taking place on the network device. The microblog analysis component 130 may then report this trending data (i.e., to a network administrator), allowing corrective actions to be performed (e.g., adding an additional network device to the system to ease the workload of the problematic network device). In a particular embodiment, the microblog analysis component 130 may collect information from the microblog messages and present this information to a user in graphical form. For example, the microblog analysis component 130 could receive microblog messages describing a data flow from a particular network address and present a histogram to the user showing the sizes of packets within the data flow.

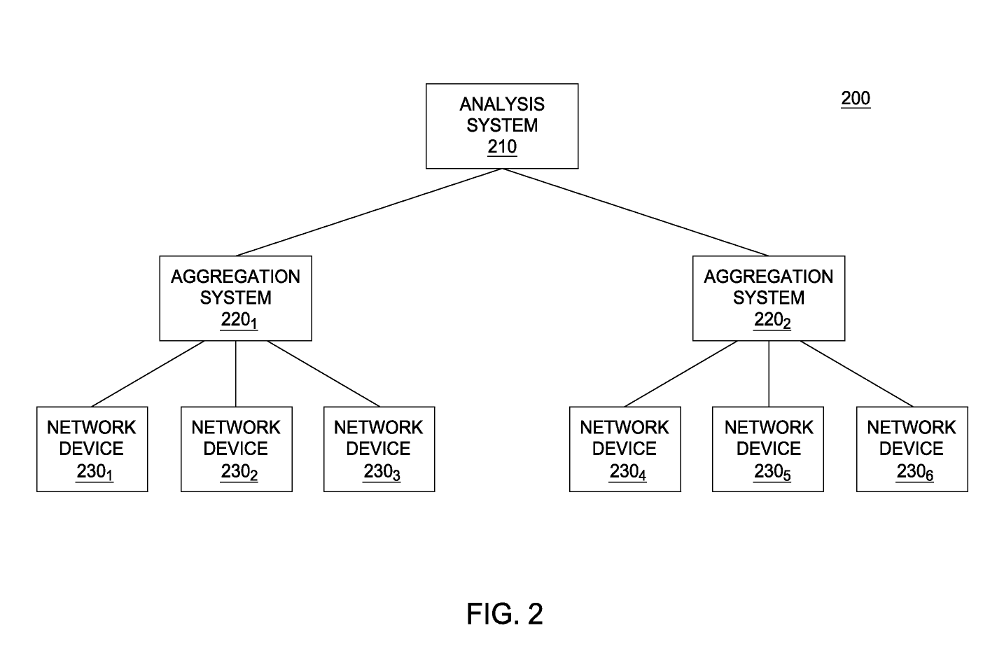

FIG. 2 illustrates a topological diagram of a hierarchical network environment, according to one embodiment presented in this disclosure. As shown, the network environment 200 contains an analysis system 210, aggregation systems 220 and network devices 230. Generally, in the depicted environment 200, the analysis system 210 subscribes to microblog messages published by each of the aggregation systems 220, and each of the aggregation systems subscribe to microblog messages published by a portion of the network devices. As discussed above, the network devices 230 may monitor (e.g., using an event detection component 110) for events, and when an event is detected, publish a microblog message based on the event. In the depicted hierarchical network environment, such a microblog message may then be transmitted (e.g., using a microblog service) to an aggregation system 220. As discussed above, the aggregation systems 220 generally consolidate the microblog messages for a set of network devices 230 and then create and publish other microblog messages based on the consolidated messages.

As an example, network devices 230₁ and 230₂ could both experience high amounts of CPU and memory consumption. An event detection component 110 on each of the devices 230 could detect the high levels of resource consumption, and a microblog component 115 on each of the devices 230 could publish a microblog message based on the high levels of resource consumption. The aggregation system 220₁ could receive these microblog messages from the devices 230₁ and 230₂ and could consolidate these messages into a single, new microblog message. The aggregation system 2201 may then publish the newly-created microblog message to a microblog service, which would then be received by the analysis system 210. Advantageously, doing so provides a highly-scalable environment for monitor network devices 230, which avoids inefficient polling of the network devices and also limits the number of subscriptions the analysis system maintains 210. Furthermore, consolidating the microblog messages from the network devices 230 using the aggregation systems 220 may minimize the amount of traffic flowing to the analysis system 210. This may be particularly advantageous, for instance, when the network devices 230 and aggregation system 220 are connected via an internal network, whereas traffic to the analysis system 210 must be communicated over an external network (e.g., the Internet).

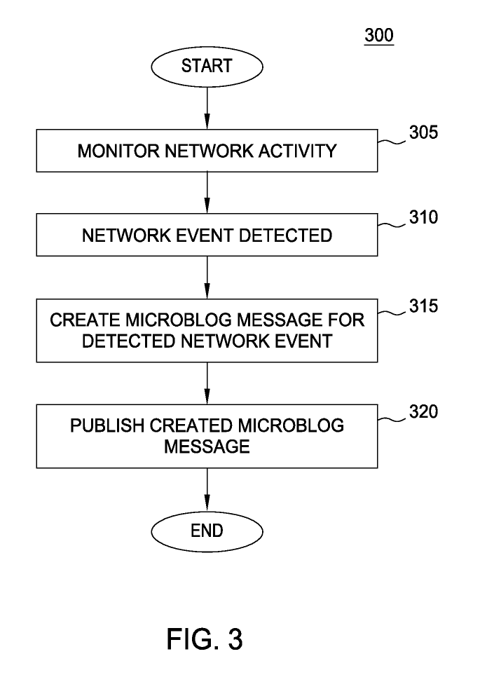

FIG. 3 is a flow diagram illustrating a method for publishing network event data, according to one embodiment described in this disclosure. As shown, the method 300 begins at step 305, where an event detection component 110 monitors network activity on a network device 100. Of course, as noted above, the event detection component 110 may also monitor other types of activity, including network traffic or other performance measures associated with the network device 100 (e.g., CPU and memory usage) as well as monitor content passing through the network device 100. At step 310, the event detection component 110 detects a network event. In response, the microblog component 115 on the network device 100 creates a microblog message based on the detected network event (step 315). The microblog component 115 then publishes the created microblog message to a microblog service. In turn, the service then transmits the microblog message to subscriber entities having a subscription to microblog messages of this type (step 320).

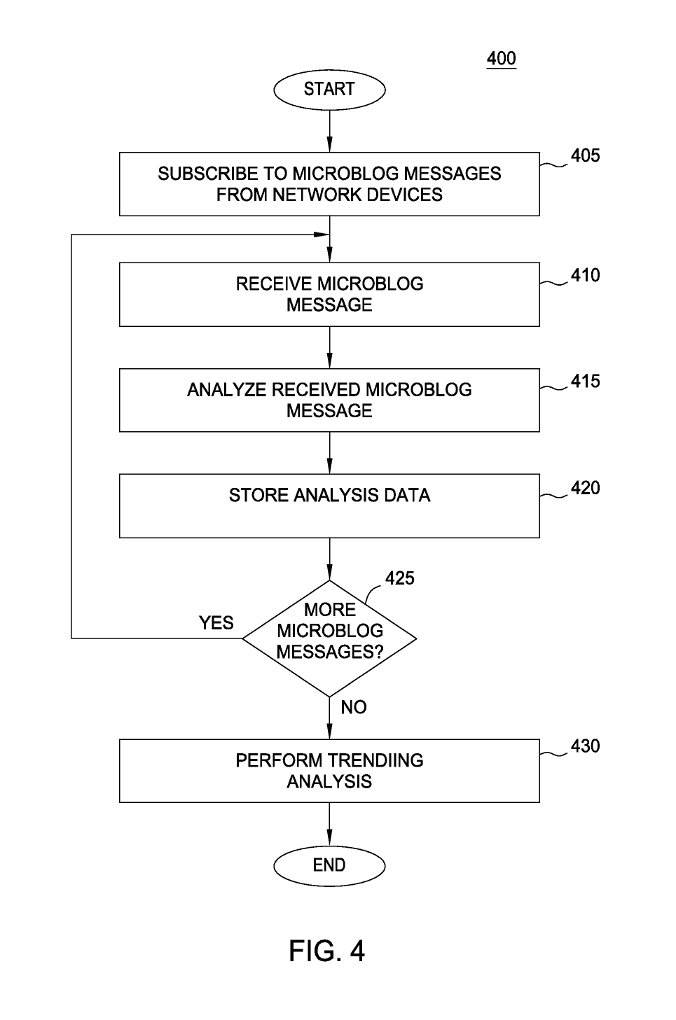

FIG. 4 is a flow diagram illustrating a method for performing a trend analysis for network devices, according to one embodiment presented in this disclosure. As shown, the method 400 begins at step 405, where a microblog analysis component 130 on an analysis system 120 subscribes to microblog messages from one or more network devices. For example, according to one embodiment, the microblog analysis component 130 may subscribe by transmitting a subscription request to a microblog service. The subscription request would specify the network devices to which the microblog analysis component 130 wishes to subscribe. As a second example, the subscription request may specify a particular type of message to which the microblog analysis component 130 wishes to subscribe. Thereafter, the microblog analysis component 130 receives microblog messages from the network devices associated with the subscription (step 410).

When the analysis component 130 receives a microblog message from a given network device, it analyzes the message to determine operational characteristics of that network device (step 415). For instance, an exemplary microblog message could contain a summary of performance metrics on the network device. The analysis system 120 could extract particular metrics of concern from the microblog message, such as CPU usage and memory usage metrics.

The microblog analysis component 130 then stores the analysis data resulting from the analysis of the microblog message (step 420). At step 425, the microblog analysis component 130 determines whether there are more microblog messages to analyze. If so, the method returns to step 410, where the microblog analysis component 130 receives the next microblog message for analysis. If not, the microblog analysis component 130 then performs a trending analysis, based on the analysis data stored from the received microblog messages (step 430), and the method 400 ends. As an example, such a trending analysis could look at the CPU usage of the network device over a period of time. If the microblog analysis component 130 determines that the network device is experiencing a high CPU load for a sufficient period of time, the microblog analysis component 130 may take corrective actions to address this problem. Such corrective actions may include, for example, reporting the trend to a network administrator (e.g., by publishing a new microblog message describing the high CPU load).

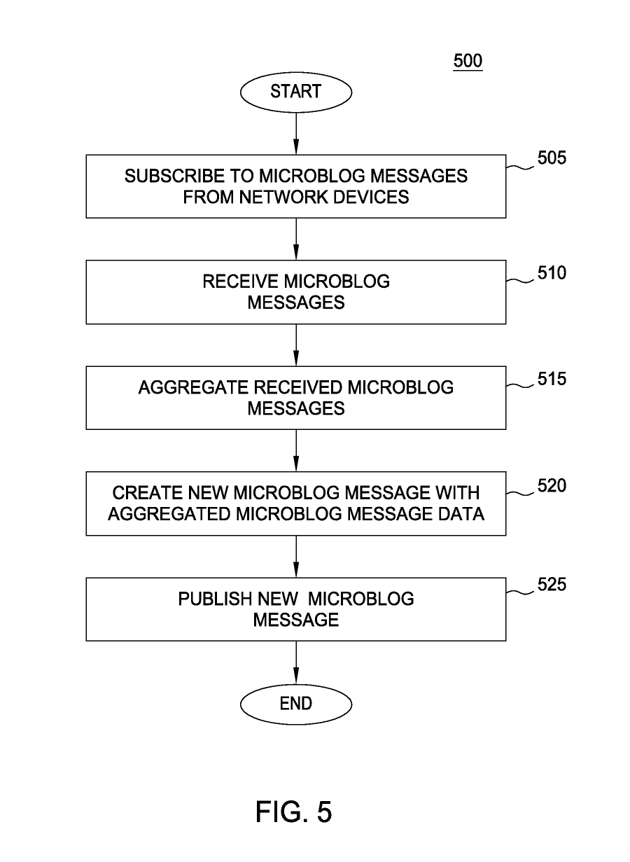

FIG. 5 is a flow diagram illustrating a method for aggregating microblog messages, according to one embodiment presented in this disclosure. As shown, the method 500 begins at step 505, where an aggregation device (e.g., aggregation system 220) subscribes to microblog messages from network devices. For example, the aggregation device may subscribe to a microblog service by sending a request specifying the network devices to which the aggregation device wishes to subscribe.

At some later point in time, responsive to the subscription, the aggregation device receives microblog messages from at least one of the network devices (step 510). The aggregation device then consolidates the received microblog messages into a single data entity (step 515). For instance, each of the received microblog messages could contain a summary of numerous performance metrics for a respective one of the network devices. In such an example, a particular aggregation device may be configured to extract only the CPU usage and memory usage metrics from each of the received microblog messages, and to then include each of these metrics (along with an identifier of the network device associated with the metrics) in a single data entity.

Once the microblog messages are consolidated, the aggregation device creates a new microblog message containing the consolidated data entity (step 520). The aggregation device then publishes the new microblog message to a microblog service, whereby the new microblog message is transmitted to one or more subscriber entities having a subscription to messages of this type. Advantageously, doing so allows the subscriber entities to receive only the relevant data from the network devices (i.e., the CPU and memory usage metrics in this example), thus minimizing the amount of network traffic used in sending these messages. Furthermore, by publishing messages from the network devices as events occur, embodiments avoid repeatedly polling the network devices to gather data from the devices. Advantageously, doing so reduces network traffic used by embodiments and improves the scalability of the network environment (relative to, say, an environment that uses polling to monitor network devices).

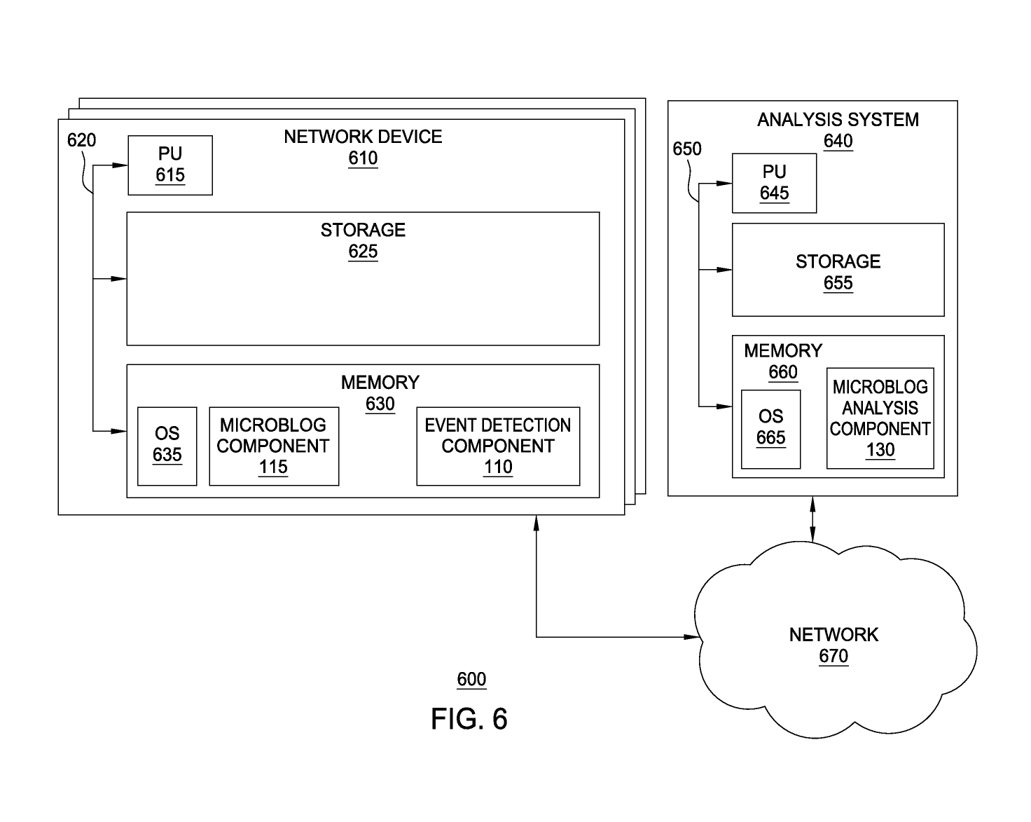

FIG. 6 is a block diagram illustrating a network environment configured with a microblog analysis component, according to one embodiment. As shown, network environment 600 includes network devices 610, a network 670 and an analysis system 660. In one embodiment, the environment 600 may include existing computer systems, e.g., desktop computers, server computers, laptop computers, tablet computers, gaming consoles, hand-held gaming devices and the like. The network environment 600 illustrated in FIG. 6, however, is merely an example of one network environment in which embodiments may be used. Embodiments may be implemented differently, regardless of whether the computer systems are complex multi-user computing systems, such as a cluster of individual computers connected by a high-speed network, single-user workstations or network appliances lacking non-volatile storage.

As shown, each network device 610 includes a processing unit 615, which obtains instructions and data via a bus 620 from a memory 630 and storage 625. Processing unit 615 is a programmable logic device that performs instruction, logic and mathematical processing, and may be representative of one or more CPUs. Storage 625 stores application programs and data for use by network device 610. The memory 630 is any memory sufficiently large to hold the necessary programs and data structures. Memory 630 could be one or a combination of memory devices, including Random Access Memory, nonvolatile or backup memory (e.g., programmable or Flash memories, read-only memories, etc.). In addition, memory 630 and storage 625 may be considered to include memory physically located elsewhere; for example, on another computer coupled to the network device 610 via bus 620.

Client storage 625 includes hard-disk drives, flash memory devices, optical media and the like. Client computer 610 is operably connected to the network 655. Client memory 630 includes an operating system (OS) 635, a microblog component 115 and an event detection component 110. Operating system 635 is the software used for managing the operation of the network device 610. Examples of OS 635 include UNIX, a version of the Microsoft Windows® operating system, and distributions of the Linux® operating system. (Note: Linux is a trademark of Linus Torvalds in the United States and other countries.) Additionally, OS 635 may be an operating system specially developed for network devices, such as Cisco IOS®.

As shown, the analysis system 640 includes the same basic hardware elements as the network devices 610. Specifically, the analysis system 640 includes a processing unit 645 (representative of one or more CPUs and/or GPUs), a memory 660 and storage 655 connected via a bus 650. The analysis system 640 may be operably connected to the network 670, which generally represents any kind of data communications network. Accordingly, the network 670 may represent both local and wide area networks, including the Internet. In one embodiment, the analysis system 640 hosts a microblog analysis component 130 which subscribes to messages sent from one or more of the network devices 610 using the microblog component 115.

Although embodiments are described above for use with respect to network devices, embodiments may be configured for use in other environments as well. For instance, consider an environment with a number of power meters (e.g., meters outside residences that measure power consumption). In accordance with one embodiment, each power meter may be configured with an event detection component and a microblog component. Here, the event detection component could monitor for the occurrence of predefined events (e.g., specified by a set of rules defined by an administrator), and upon detecting the occurrence of one of the predefined events, the microblog component could create a microblog message based on the event and transmit the microblog message to a microblog service for further transmittal to subscribers. Such subscribers may include, for instance, an analysis system, which could analyze data in the microblog message. Such data could be used to determine the monthly power consumption for a residence (e.g., for purposes of calculating the monthly bill), or could be used for trending information over a period of months or for a plurality of residences (e.g., a neighborhood).

Furthermore, it is contemplated that such an embodiment may also use a hierarchical environment (similar to the one shown in FIG. 2 and discussed above). For instance, one or more aggregation devices could receive the microblog messages from each of the power meters, and could consolidate these microblog messages into a single microblog message. The consolidated microblog message could then be published and subsequently received by, for instance, the analysis system. As discussed above, the analysis system could then analyze the microblog message to determine characteristics and trends of the power consumption of the residences associated with the power meters.

As another example, embodiments may similarly be configured for use with water meters, and used to detect characteristics and behavior of water consumption of residences and businesses. For instance, each water meter could be configured to publish microblog messages based on a measurement of water consumption, and an analysis system could receive these microblog messages and determine characteristics and trends of water consumption based on the messages. As an example, such an embodiment could be used to detect water leaks in residences. That is, if the analysis system could maintain historical trending data for the water consumption of a particular residence, and upon detecting that the residence is currently using an unusually high amount of water, could determine that the residence may be experiencing a water leak. The analysis system could then take one or more corrective actions based on this determination, such as alerting the home owner and/or a technician about the potential leak.

Additionally, it is specifically contemplated that embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Cloud computing resources may be provided to a user on a pay-per-use basis, where users are charged only for the computing resources actually used (e.g., an amount of storage space consumed by a user or a number of virtualized systems instantiated by the user). A user can access any of the resources that reside in the cloud at any time, and from anywhere across the Internet. In context of the present disclosure, a user may access applications (e.g., the microblog analysis component 130) or related data available in the cloud. For example, the microblog analysis component 130 could execute on a computing system in the cloud and could subscribe to messages from one or more network devices configured to run a microblog component 115. In such a case, the microblog analysis component 130 could receive messages from the network devices and could analyze the received messages in order to monitor the network devices and to determine performance trends across the network devices. Doing so allows users and content management system administrators to monitor and analyze the performance of the network devices from any computing system attached to a network connected to the cloud (e.g., the Internet).

As will be appreciated by one skilled in the art, embodiments may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to particular embodiments, other and further embodiments may be devised without departing from the basic scope thereof. In view of the foregoing, the scope of the present disclosure is determined by the claims that follow.

We claim:

1. A method for reporting events on a network device, comprising:
monitoring network traffic traversing the network device to detect network events;
monitoring one or more performance metrics of the network device to detect performance events;
in response to detecting at least one of a network event or a performance event, generating, by the network device, a microblog message containing at least a description of the detected event; and
transmitting, by the network device, the generated microblog message to a microblog service, wherein the microblog service is configured to forward the microblog message on to one or more subscribers registered with the microblog service to receive messages having specified characteristics of the transmitted microblog message.

2. The method of claim 1, wherein the one or performance metrics include at least one of CPU usage, memory usage, errors, temperature, and voltage.

3. The method of claim 1, wherein the network events include at least one of latency, packet loss, content detection and service status.

4. The method of claim 1, wherein the generated microblog message includes operational data relating to performance of the network device.

5. The method of claim 1, wherein the generated microblog message includes operational data relating to the monitored network traffic traversing the network device.

6. The method of claim 1, wherein the generated microblog message is defined using a markup language.

7. A network device, comprising:
a processor; and
a memory to store executable code which, when executed on the processor, performs a method for reporting events, comprising:
monitoring network traffic traversing the network device to detect network events;
monitoring one or more performance metrics of the network device to detect performance events;
in response to detecting at least one of a network event or a performance event, generating a microblog message containing at least a description of the detected event; and
transmitting the generated microblog message to a microblog service, wherein the microblog service is configured to forward the microblog message on to one or more subscribers registered with the microblog service to receive messages having specified characteristics of the transmitted microblog message.

8. The network device of claim 7, wherein the one or performance metrics include at least one of CPU usage, memory usage, errors, temperature, and voltage.

9. The network device of claim 7, wherein the network events include at least one of latency, packet loss, content detection and service status.

10. The network device of claim 7, wherein the generated microblog message includes operational data relating to performance of the network device.

11. The network device of claim 7, wherein the generated microblog message includes operational data relating to the monitored network traffic traversing the network device.

12. The network device of claim 7, wherein the generated microblog message is defined using a markup language.

13. A computer program product, comprising:
computer code that monitors network traffic traversing a network device to detect network events;
computer code that monitors one or more performance metrics of the network device to detect performance events;
computer code that, in response to detecting at least one of a network event or a performance event, generates, at the network device, a microblog message containing at least a description of the detected event;
computer code that transmits, at the network device, the generated microblog message to a microblog service, wherein the microblog service is configured to forward the microblog message on to one or more subscribers registered with the microblog service to receive messages having specified characteristics of the transmitted microblog message; and
a computer readable medium that stores the computer codes.

14. The computer program product of claim 13, wherein the one or performance metrics include at least one of CPU usage, memory usage, errors, temperature, and voltage.

15. The computer program product of claim 13, wherein the network events include at least one of latency, packet loss, content detection and service status.

16. The computer program product of claim 13, wherein the generated microblog message includes operational data relating to performance of the network device.

17. The computer program product of claim 13, wherein the generated microblog message includes operational data relating to the monitored network traffic traversing the network device.

18. The computer program product of claim 13, wherein the generated microblog message is defined using a markup language.

19. A method, comprising:
receiving a plurality of microblog messages from a first microblog service, wherein the plurality of microblog messages contain operational data relating to performance of a plurality of network devices;
generating a second microblog message containing at least a description of the received plurality of microblog messages; and
transmitting the generated second microblog message to a second microblog service, wherein the second microblog service forwards the second microblog message to one or more subscribers registered with the second microblog service to receive messages having specified characteristics of the transmitted second microblog message, wherein the one or more subscribers are configured to monitor the plurality of network devices.

20. The method of claim 19, further comprising:
sending a request to the first microblog service to subscribe to microblog messages having specified characteristics and relating to the plurality of network devices.

21. The method of claim 20, wherein the request is to subscribe to microblog messages published by the plurality of network devices, and wherein the plurality of microblog messages are received from the first microblog service in response to at least one of the network devices transmitting a first microblog message to the first microblog service.

22. The method of claim 19, wherein at least one of the subscribers is further configured to analyze the plurality of microblog messages to determine one or more operational attributes of the plurality of network devices.

23. The method of claim 22, wherein at least one of the subscribers is further configured to compare the operational attributes with historical data for the plurality of network devices to identify trending information for the plurality of network devices over a period of time.

24. The method of claim 19, wherein the first microblog service is the same as the second microblog service.
